(19) United States
(12) Patent Application Publication
(10) Pub. No.: US 2025/0161978 A1
(43) Pub. Date: May 22, 2025

(54) VEHICLE INCLUDING MULTI-TONE PAINT SCHEME

(71) Applicant: GM GLOBAL TECHNOLOGY OPERATIONS LLS, Detroit, MI (US)

(72) Inventors: Hua-tzu Fan, Troy, MI (US); Marcel James ISROW, Bruce Township, MI (US); Ryan J. ODEGAARD, Ludington, MI (US); John Patrick SPICER, Plymouth, MI (US); Michael J. MOORE, Rochester, MI (US); Jorge F. ARINEZ, Rochester Hills, MI (US)

(21) Appl. No.: 18/512,676

(22) Filed: Nov. 17, 2023

(51) Int. Cl. B05D 1/32; B29C 63/00

(52) U.S. Cl. CPC B05D 1/32; B29C 63/0004

(57) ABSTRACT

A method for providing a vehicle with a multi-tone paint scheme, the method including: applying a first paint of a first color to a body of the vehicle with a panel of the vehicle detached from the body of the vehicle; applying a film onto the panel, the film including a second paint of a second color that is different from the first color; and mounting the panel to the body of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a vehicle including a multi-tone paint scheme and methods for applying the multi-tone paint scheme.

Vehicle bodies often have a single-tone paint scheme, which means that the body is painted to have only one color. Some vehicle bodies have a two-tone paint scheme, which means that different areas of the body are painted in different colors. For example, a vehicle painted with a two-tone paint scheme may have a roof and an area of the body below the roof painted in different colors. A two-tone paint scheme typically requires more time and energy to apply as compared to a single-tone paint scheme.

### SUMMARY

The present disclosure includes, in various features, a method for providing a vehicle with a multi-tone paint scheme, the method including: applying a first paint of a first color to a body of the vehicle with a panel of the vehicle detached from the body of the vehicle; applying a film onto the panel, the film including a second paint of a second color that is different from the first color; and mounting the panel to the body of the vehicle.

In further features, the panel is a roof panel.

In further features, the panel is a door panel.

In further features, applying the film onto the panel includes applying the film by a thermal vacuum forming process.

In further features, the present disclosure includes, prior to applying the film onto the panel, pre-treating the panel by anodizing the panel.

In further features, the present disclosure includes, prior to applying the film onto the panel, pre-treating the panel with an electrocoating.

In further features, the present disclosure includes applying the first paint to a first area and a second area of the panel prior to applying the film to the panel, masking the first area to cover the first paint, applying the film to the second area over the first paint by thermal vacuum forming, and demasking the first area.

In further features, the present disclosure includes masking a first area of the panel prior to applying the film onto the panel, and applying the film by thermal vacuum forming to a second area of the panel that is different from the first area.

In further features, the film includes an adhesive; and applying the film onto the panel further includes placing the film on a support fixture with the adhesive facing outward, placing the panel on the support fixture such that the film adheres to the panel by way of the adhesive, and wrapping the film around the panel.

In further features, the film further includes a third paint of a third color that is different from the second color.

In further features, the present disclosure includes mounting a cover to the panel at a border area between the second paint and the third paint.

In further features, the present disclosure includes forming the film by applying the second paint and the third paint onto the film.

In further features, the present disclosure includes aligning the panel on the vehicle by moving panel locating members of the panel into cooperation with vehicle locating members of the vehicle.

In further features, the present disclosure includes, aligning the panel on the vehicle with a machine vision camera.

The present disclosure further includes, in various features, a method for providing a vehicle with a multi-tone paint scheme, the method including: applying a first paint of a first color to the vehicle; forming a paint film including a second paint of a second color and a third paint of a third color, the second color is different from the third color; applying the paint film to a panel of the vehicle by thermal vacuum forming; and mounting the panel to the vehicle.

In further features, forming the paint film further includes: applying the second paint of the second color over an entire width of the paint film; curing the second paint; and applying the third paint of the third color on less than an entirety of the second paint.

In further features, forming the paint film further includes simultaneously applying the second paint to a first area of the paint film and applying the third paint to a second area of the paint film that is different from the first area.

In further features, the present disclosure includes aligning the panel, the second color, and the third color with the vehicle by moving panel locating members of the panel into cooperation with vehicle locating members of the vehicle; and verifying alignment of the panel, the second color, and the third color with a machine vision camera.

The present disclosure additionally includes, in various features, a vehicle including a multi-tone paint scheme, the vehicle including: a first paint of a first color painted on a body of the vehicle; and a panel mounted to the body, the panel including a film adhered to the panel by thermal vacuum forming, the film including a second paint of a second color and a third paint of a third color, at least one of the second color and the third color is different from the first color.

In further features, the panel is one of a roof panel, a door panel, and a hood panel.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a top view of an exemplary vehicle including an exemplary multi-tone paint scheme in accordance with the present disclosure, the vehicle including a body painted with a first paint of a first color and a roof panel covered in a film including a second paint of a second color that is different from the first color;

FIGS. 2A, 2B, and 2C illustrate an exemplary process for applying the film to the roof panel by thermal vacuum forming;

FIG. 3 illustrates a method for providing a vehicle with a multi-tone paint scheme in accordance with the present disclosure;

FIGS. 4A and 4B illustrate application of the film including the second paint of the second color to a window frame of an exemplary vehicle door in accordance with another method of the present disclosure;

FIGS. 5A and 5B illustrate application of the film including the second paint of

the second color to the window frame in accordance with an additional method of the present disclosure, the method including use of a support fixture for holding the film prior to application of the film to the window frame;

FIG. 6 illustrates an exemplary vehicle door panel with the film covering the window frame and a body of the door panel, at the window frame the film includes the second paint of the second color, and at the body the film includes a third paint of a third color that is different from the second color;

FIG. 7 illustrates an exemplary method in accordance with the present disclosure for preparing the film including both the second paint of the second color and the third paint of the third color;

FIG. 8 illustrates a paint film manufacturing system in accordance with the present disclosure for making a paint film having two or more colors; and

FIG. 9 illustrates a system in accordance with the present disclosure for aligning the roof panel on the vehicle.

In the drawings, reference numbers may be reused to identify similar and/or identical elements.

### DETAILED DESCRIPTION

FIG. 1 illustrates an exemplary vehicle 10 including a multi-tone paint scheme in accordance with the present disclosure. Although the figures illustrate the multi-tone paint scheme applied to a vehicle, the present disclosure applies to non-vehicular applications as well. Thus, the methods and systems for providing a multi-tone paint scheme set forth herein apply to vehicles and any other suitable structures, surfaces, etc.

The vehicle 10 of FIG. 1 includes a body 12 including various panels, such as door panels 14, a roof panel 16, and a hood panel 18. In the example of FIG. 1, other than the roof panel 16, the body 12 is painted with a first paint 50 including a first color. The first paint 50 is applied in any suitable manner, such as by spraying the first paint 50 onto the panels of the body 12.

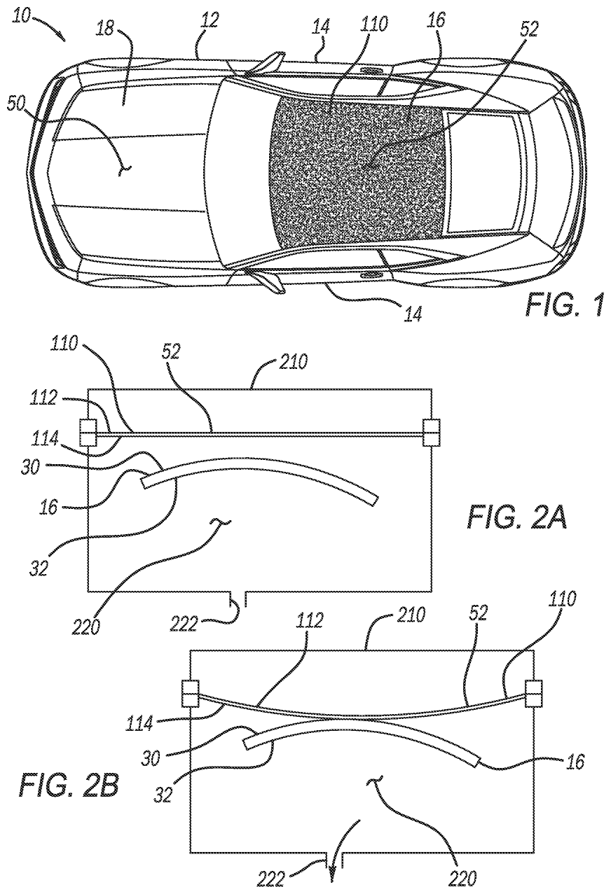

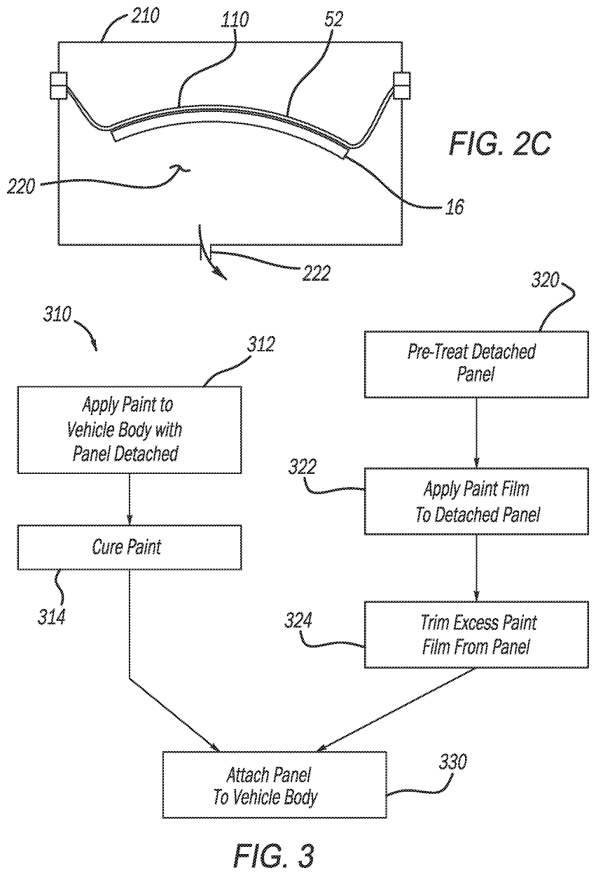

The roof panel 16 is covered with a film 110. The film 110 may be made of any suitable material, such as any suitable polymeric material including, but not limited to, acrylic polyurethane, acrylonitrile butadiene styrene (ABS), high impact polystyrene (HIPS), or polyethylene terephthalate glycol (PETG). The film 110 includes a second paint 52. The second paint 52 has a second color, which is different from the first color of the first paint 50. As illustrated in FIG. 2A, the film 110 includes an outer film surface 112 to which the second paint 52 is applied. An inner film surface 114 of the film 110 is opposite to the outer film surface 112. The inner film surface 114 includes an adhesive.

The film 110 is applied to the roof panel 16 by thermal vacuum forming, as explained herein. The film 110 may be applied to the roof panel 16 in any other suitable manner as well. FIGS. 2A, 2B, and 2C illustrate an exemplary process for applying the film 110 onto the roof panel 16 by thermal vacuum forming. The process of FIGS. 2A, 2B, and 2C may also be used to apply the film 110 to any other panel of the vehicle 10, as well as to any other suitable surface.

With initial reference to FIG. 2A, the film 110 and the panel 16 are placed within a vacuum box 210, and specifically an air-tight chamber 220 of the vacuum box 210. The panel 16 includes an outer panel surface 30, which is opposite to an inner panel surface 32. To apply the film 110 to the panel 16 by thermal vacuum forming, the film 110 is heated, and then air is drawn out of the air-tight chamber 220 through an outlet 222 by applying a vacuum. With reference to FIGS. 2B and 2C, the vacuum draws the inner film surface 114 onto the outer panel surface 30. The adhesive on the inner film surface 114 secures the film 110 to the outer panel surface 30. In the example of FIG. 2C, the film 110 covers an entirety of the outer panel surface 30. Excess portions of the film 110 are removed in any suitable manner, such as by laser cutting.

FIG. 3 illustrates an exemplary method 310 in accordance with the present disclosure for providing the vehicle 10 with the multi-tone paint scheme. The method 310 applies to any suitable vehicle and may be applied in any other suitable application to provide a multi-tone paint scheme. With initial reference to block 312, one or more panels of the body 12 (e.g., door panels 14, roof panel 16, hood panel 18) are removed from the vehicle 10 to provide the removed panels with a different color from the rest of the body 12. With the panel(s) removed, the body 12 is painted with the first paint 50 of the first color using any suitable painting process. At block 314, the first paint 50 is cured. Before, after, or during application of the first paint 50, the detached panel is pretreated at block 320. The pretreatment depends on the composition of each particular body panel. For example, a composite body panel may not require pretreatment. A steel, aluminum or mixed metal body panel is pretreated by applying a thin film or phosphate to the panel, and an electrocoating. For all aluminum body panels, the panel can be treated with any suitable anodizing process.

After the panel has been pretreated at block 320, the method 310 proceeds to block 322. At block 322, the film 110 including the second paint 52 of the second color (which is different from the first color of the first paint 50) is applied to the detached panel. For example, the film 110 may be applied to the roof panel 16, as illustrated in FIGS. 1, 2A, 2B and 2C. The film 110 may be applied to any other suitable panel as well. For example, the film 110 may be applied to one or more door panels 14, the hood panel 18, or any other suitable panel of the body 12 or elsewhere on the vehicle 10. From block 322, the method 310 proceeds to block 324. At block 324, excess film 110 is trimmed from the panel to which the film has been applied, such as by laser trimming. At block 330, the panel including the film 110 is attached to the body 12 of the vehicle 10, which includes the first paint 50 of the first color to provide the vehicle 10 with a multi-tone paint scheme. Additional films 110 including the second paint 52, or paint of a different color, may be applied to any other panel of the body 12 as well.

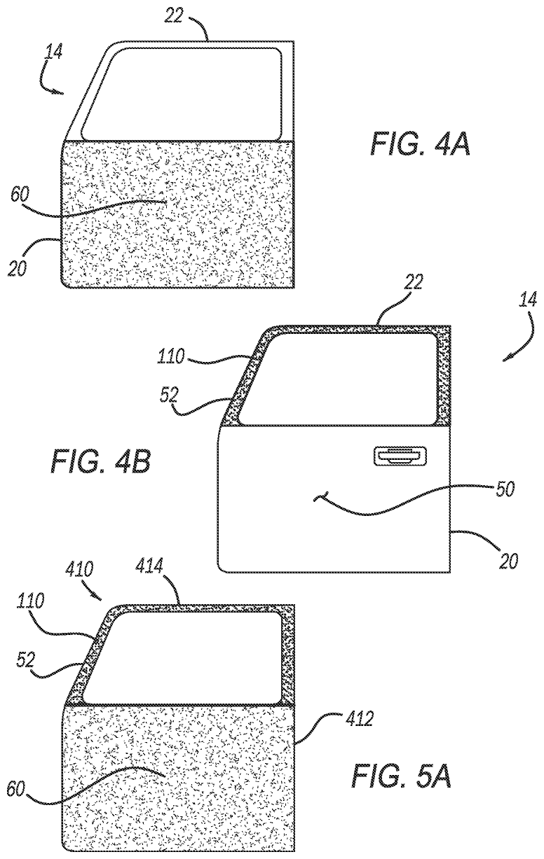

FIGS. 4A and 4B illustrate application of the film 110 to a window frame of the door panel 14. The door panel 14 includes a first area 20, which includes a body of the door panel 14, and a second area 22, which includes the window frame of the door panel 14. Prior to application of the film 110, the entire door panel 14 (including the first area 20 and the second area 22) may be painted with the first paint 50, painted with any other colored paint, or the door panel 14 may be in a body-in-white condition. The first area 20 is covered in any suitable manner, such as with any suitable mask 60, as illustrated in FIG. 4A. The film 110 is then applied to the second area 22, which in this example is the window frame. The film 110 may be applied by thermal vacuum forming in the manner described above and illustrated in FIGS. 2A-2C with respect to the roof panel 16, or may be applied in any other suitable manner. The mask 60 is removed after the film 110 is applied. The result is the door panel 14 with the first area 20 painted with the first paint 50 of the first color, and the second area 22 covered with the film 110 painted with the second paint 52 of the second color.

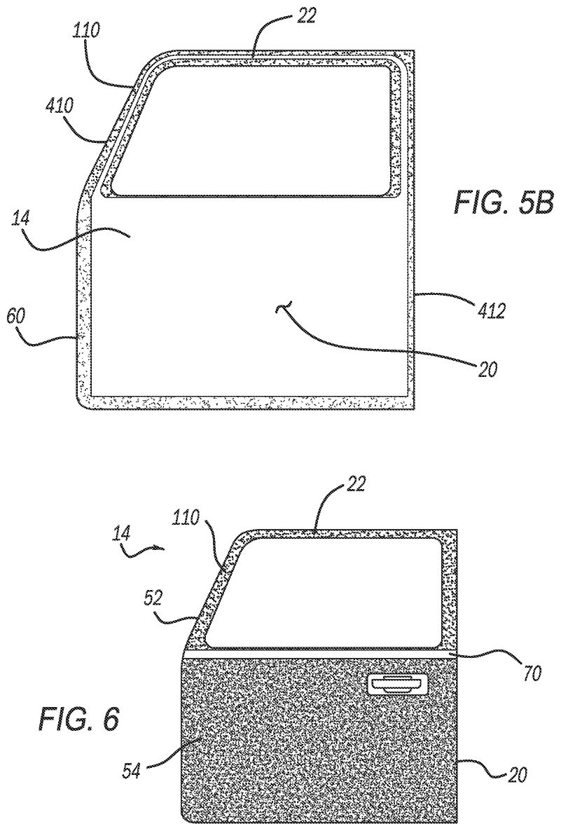

FIGS. 5A and 5B illustrate use of a support fixture 410 to facilitate application of the film 110 to the second area of the door panel 14. With particular reference to FIG. 5A, the support fixture 410 is generally sized and shaped to correspond to the size and shape of the door panel 14. The support fixture 410 is shaped like an exterior surface of the door panel 14, but slightly larger to allow excess portions of the film 110 to be wrapped around the door panel 14 as described below. Thus, the support fixture 410 includes a body 412, which is generally sized and shaped to match the size and shape of the first area 20 of the door panel 14. The support fixture 410 further includes a frame 414, which is generally sized and shaped to approximate the second area 22 of the door panel 14. To apply the film 110 to the second area 22 of the door panel 14, the film 110 is first seated on the frame 414 of the support fixture 410 with the inner film surface 114 facing upward. The inner film surface 114 includes an adhesive, as explained above in the description of FIGS. 2A-2C.

The film 110 may be pre-cut and laid upon only the frame 414. Alternatively, the film 110 may be laid across a greater portion of the support fixture 410, such as across both the frame 414 and the body 412. Any portion of the film 110 that is not intended to be transferred to the door panel 14 is covered by any suitable mask 60. The mask 60 has a non-stick surface to prevent the inner film surface 114 of the film 110 from adhering thereto.

The support fixture 410 includes a plurality of holes through which a vacuum may be pulled from a backside of the support fixture 410. The film 110 is heated through the support fixture 410, and vacuum is pulled from the backside of the support fixture 410 to shape the film 110. Pressure may be applied on the film 110 from the front side of the support fixture 410 to push the film 110 against the support fixture 410.

With reference to FIG. 5B, after the film 110 is set on the support fixture 410, the door panel 14 is seated on the support fixture 410 and pressed against the film 110. As a result, the adhesive on the inner film surface 114 adheres the film 110 to the second area 22 of the door panel 14. Excess material of the film 110 is wrapped around the second area 22 of the door panel 14 with any suitable crimping tool (such as a cylindrical rolling tool) and sealed in any suitable manner. Excess portions of the film 110 may also be cut, such as with a laser cutting device. The first area 20 of the door panel 14 may be painted in any suitable manner in any suitable color. For example, the first area 20 may be painted with the first paint 50 prior to application of the film 110.

FIG. 6 illustrates the door panel 14 including the film 110 applied thereto by thermal vacuum forming (such as described above in the description corresponding to FIGS. 2A, 2B, 2C) or in any other suitable manner. The film 110 is applied to both the first area 20 and the second area 22 of the door panel 14. The portion of the film 110 covering the second area 22 is painted with the second paint 52 of the second color. The portion of the film 110 covering the first area 20 is painted with a third paint 54 of a third color. Any suitable cover 70 (which may be configured as a trim piece, for example) is mounted to the door panel 14 at a transition area between the second paint 52 and the third paint 54. The cover 70 advantageously obscures the transition area. Thus, in the example of FIG. 6, the film 110 includes both the second paint 52 and the third paint 54 having different colors to provide the door panel 14 with a two-tone color configuration. The film 110 may further include more than two paint colors, to provide the door panel 14 with more than two colors.

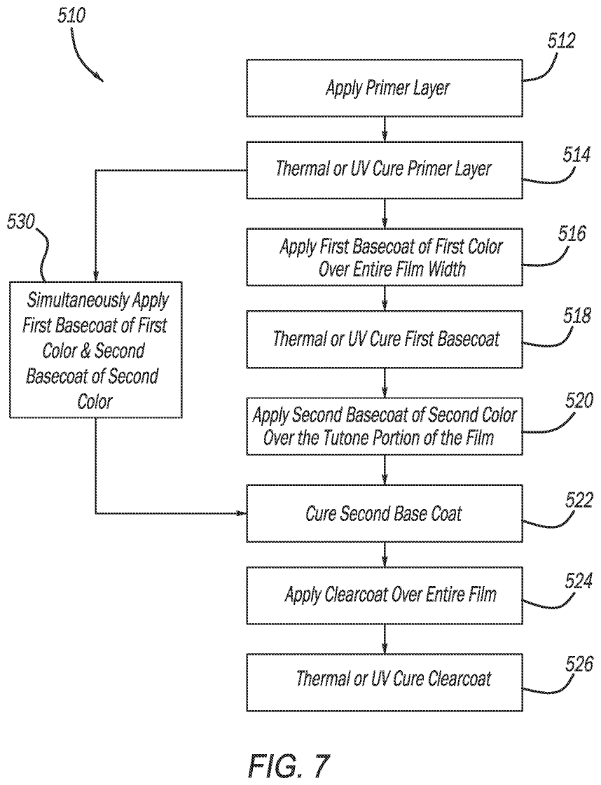

FIG. 7 illustrates an exemplary method 510 for applying multiple paints to the film 110. At block 512 of the method 510, any suitable primer layer is first applied to the film 110. At block 514, the primer layer is cured in any suitable manner, such as by thermal or ultraviolet curing. The second paint 52 and the third paint 54 may be applied individually or simultaneously. When applied individually, the method 510 proceeds to block 516. At block 516, a first base coat of a first color is applied over an entire width of the film 110. For example, the second paint 52 of the second color may be applied over an entire width of the film 110. At block 518, the first base coat, such as the second paint 52, is cured by thermal or ultraviolet curing. At block 520, a second base coat of a second color is applied over a portion of the film 110 where the second color is desired. Thus, when the second paint 52 is applied over the entire width of the film 110, the third paint 54 will be applied over a portion of the second paint 52 where the third color is desired. At block 522, the second base coat is cured in any suitable manner, such as with an ambient or heated flash. At block 524, any suitable clear coat is applied over the entire film 110, such as over the second paint 52 and the third paint 54. At block 526, the clear coat is cured by thermal or ultraviolet curing.

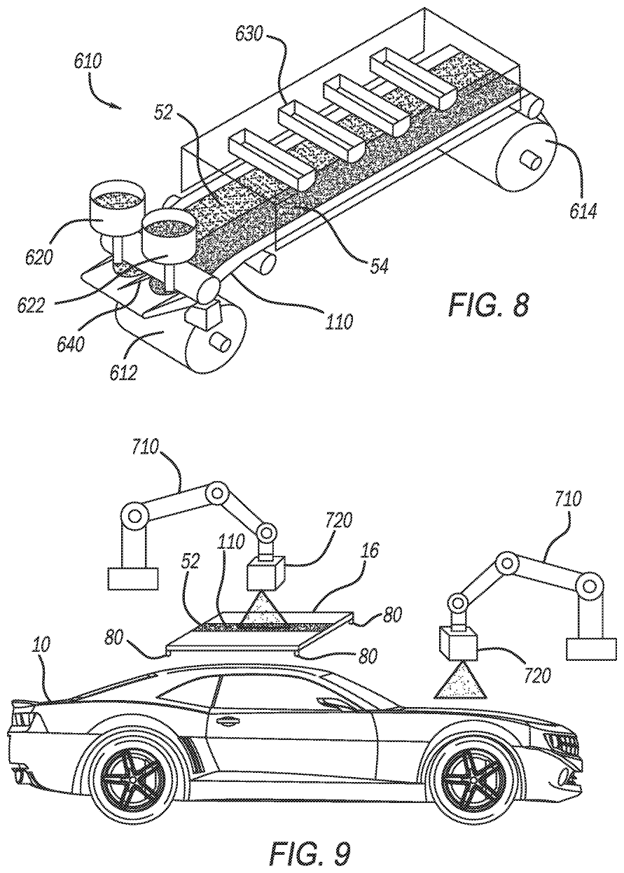

The first base coat and the second base coat may also be applied simultaneously. For example, after the primer layer is cured at block 514, the method 510 may proceed to block 530. At block 530, both the first base coat and the second base coat are applied simultaneously. From block 530, the method proceeds to block 522. FIG. 8 illustrates an exemplary system 610 for applying the first base coat and the second base coat simultaneously.

In the example of FIG. 8, the first base coat may be the second paint 52 of the second color, and the second base coat may be the third paint 54 of the third color. The system 610 includes a first roller 612 and a second roller 614. The film 110 is rolled off of the first roller 612 onto the second roller 614. The system 610 includes a first hopper 620 and a second hopper 622. In the example illustrated, the first hopper 620 includes the second paint 52, and the second hopper 622 includes the third paint 54. The first hopper 620 is arranged over a first area of the film 110 and the second hopper 622 is arranged over a second area of the film 110. The first and second areas are adjacent to one another with a separator 640 therebetween to separate the two colors and maintain a fixed separation line between the two colors on the film. Between the first roller 612 and the second roller 614 are a plurality of dryers 630. As the film is rolled off of the first roller 612 onto the second roller 614, the first base coat is deposited onto the film 110 from the first hopper 620, and the second base coat is deposited onto the film 110 from the second hopper 622. The first and second base coats are dried by the dryer 630 prior to reaching the second roller 64.

In the example of FIG. 8, the first base coat is the second paint 52, and the second base coat is the third paint 54. However, any suitable paint of any color may be deposited onto the film 110 by way of the first and second hoppers 620, 622. The position of the first and second hoppers 620, 622 may be at any suitable location relative to the film 110. In the example illustrated, the first and second hoppers 620, 622 deposit the respective paints adjacent to one another. However, the hoppers 620, 622 may be at any other suitable position relative to the film 110. Although FIG. 8 illustrates two hoppers, more than two hoppers may be included in order to deposit additional base coats of additional colors. A paint distributor is used to collect paint from the hoppers 620, 622 and distribute the paint evenly onto the film 110. The separator 640 separates the paint from the two hoppers 620, 622 and creates a fixed separation line on the film 110. The separator 640 is movable to adjust the separation line on the films 110.

With reference to FIG. 9, the roof panel 16 includes a plurality of locating members 80, each one of which is configured to cooperate with a corresponding locator of the vehicle 10. In the example illustrated, the locating members 80 are configured as tabs extending from an undersurface of the roof panel 16. The locating members 80 are configured to be received by suitable receptacles of the vehicle 10, which are positioned to ensure proper alignment of the roof panel 16 and the painted film 110 applied thereto. Any of the other painted panels of the vehicle 10 may also include the locating members 80, such as the door panels 14, the hood panel 18, etc.

Once the painted panel is mounted to the vehicle 10, the alignment thereof may be verified in any suitable manner, such as with any suitable machine vision inspection system. In the example of FIG. 9, robotic arms 710 include machine vision cameras 720. The robotic arms 710 are configured to maneuver the cameras 720 to verify alignment of the painted features of the roof panel 16 or any other panel of the vehicle 10. In the example of FIG. 9, the roof panel 16 includes the film 110 painted with the second paint 52, and arranged as a stripe extending along a center of the roof panel 16. The locating members 80 are configured to cooperate with receptacles of the vehicle 10 to properly position the stripe. The robotic arms 710 maneuver the cameras 720 to scan the stripe and surrounding areas of the vehicle 10 to verify proper positioning of the stripe. The cameras 720 can be configured to verify alignment of any other painted features of the roof panel 16, or any other panel of the vehicle 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for providing a vehicle with a multi-tone paint scheme, the method comprising:
applying a first paint of a first color to a body of the vehicle with a panel of the vehicle detached from the body of the vehicle;
applying a film onto the panel, the film including a second paint of a second color that is different from the first color; and
mounting the panel to the body of the vehicle.

2. The method of claim 1, wherein the panel is a roof panel.

3. The method of claim 1, wherein the panel is a door panel.

4. The method of claim 1, wherein applying the film onto the panel includes applying the film by a thermal vacuum forming process.

5. The method of claim 1, further comprising, prior to applying the film onto the panel, pre-treating the panel by anodizing the panel.

6. The method of claim 1, further comprising, prior to applying the film onto the panel, pre-treating the panel with an electrocoating.

7. The method of claim 1, further comprising applying the first paint to a first area and a second area of the panel prior to applying the film to the panel, masking the first area to cover the first paint, applying the film to the second area over the first paint by thermal vacuum forming, and demasking the first area.

8. The method of claim 1, further comprising masking a first area of the panel prior to applying the film onto the panel, applying the film by thermal vacuum forming to a second area of the panel that is different from the first area.

9. The method of claim 1, wherein:
the film includes an adhesive; and
applying the film onto the panel further includes placing the film on a support fixture with the adhesive facing outward, placing the panel on the support fixture such that the film adheres to the panel by way of the adhesive, and wrapping the film around the panel.

10. The method of claim 1, wherein the film further includes a third paint of a third color that is different from the second color.

11. The method of claim 10, further comprising mounting a cover to the panel at a border area between the second paint and the third paint.

12. The method of claim 10, further comprising forming the film by applying the second paint and the third paint onto the film.

13. The method of claim 10, further comprising aligning the panel on the vehicle by moving panel locating members of the panel into cooperation with vehicle locating members of the vehicle.

14. The method of claim 10, further comprising aligning the panel on the vehicle with a machine vision camera.

15. A method for providing a vehicle with a multi-tone paint scheme, the method comprising:
applying a first paint of a first color to the vehicle;
forming a paint film including a second paint of a second color and a third paint of a third color, the second color is different from the third color;
applying the paint film to a panel of the vehicle by thermal vacuum forming; and
mounting the panel to the vehicle.

16. The method of claim 15, wherein forming the paint film further includes:
applying the second paint of the second color over an entire width of the paint film;
curing the second paint; and
applying the third paint of the third color on less than an entirety of the second paint.

17. The method of claim 15, wherein forming the paint film further includes simultaneously applying the second paint to a first area of the paint film and applying the third paint to a second area of the paint film that is different from the first area.

18. The method of claim 15, further comprising:
aligning the panel, the second color, and the third color with the vehicle by moving panel locating members of the panel into cooperation with vehicle locating members of the vehicle; and
verifying alignment of the panel, the second color, and the third color with a machine vision camera.

19. A vehicle including a multi-tone paint scheme, the vehicle comprising:
a first paint of a first color painted on a body of the vehicle; and
a panel mounted to the body, the panel including a film adhered to the panel by thermal vacuum forming, the film including a second paint of a second color and a third paint of a third color, at least one of the second color and the third color is different from the first color.

20. The vehicle of claim 19, wherein the panel is one of a roof panel, a door panel, and a hood panel.
